(19) United States
(12) Patent Application Publication
(10) Pub. No.: US 2005/0140516 A1
(43) Pub. Date: Jun. 30, 2005

(54) Power tool

(75) Inventors: Zhao Kong, Suzhou (CN); Guoliang Mou, Suzhou (CN)

Correspondence Address: MADSON & METCALF;GATEWAY TOWER WEST, SUITE 900, 15 WEST SOUTH TEMPLE, SALT LAKE CITY, UT, 84101, US

(73) Assignee: Positec Power Tools (Suzhou) Co. Ltd.

(21) Appl. No.: 11/022,345

(22) Filed: Dec. 23, 2004

(30) Foreign Application Priority Data
Dec. 24, 2003 (CN) 200320123520.9

(51) Int. Cl. G08B 21/00

(52) U.S. Cl. 340/654; 340/680

(57) ABSTRACT

The present invention relates to a power tool comprises a supply wire, a power switch and a first electrical circuit including the power switch. The power tool further comprises a power indicating device which includes a power indicator which can emit light visible to indicate whether power is on or off and forming a second electrical circuit. The second electrical circuit and the first electrical circuit are connected in parallel to the supply wire.

### BACKGROUND OF THE INVENTION

The present invention relates to a power tool having a power indicating device.

Conventional power tools are commonly provided with a rather long supply wire for convenient long range use. However, if there is motor damage or the power plug thereof is carelessly loosened or detached from the power jack, the power tool may stop working suddenly. In these circumstances, the operator determines whether the power is on or off by walking up to the remote power plug. This is a rather time-consuming exercise and may inconveniently prolong operating time.

### SUMMARY OF THE INVENTION

An object of the present invention is to overcome certain disadvantages of the prior art by providing a power tool having a power indicating device positioned in visible proximity to an operator to indicate whether power is on or off.

A power tool comprises a supply wire, a power switch and a first electrical circuit including the power switch. The power tool further comprises a power indicating device which includes a power indicator which can emit light visible to indicate whether power is on or off and forming a second electrical circuit. The second electrical circuit and the first electrical circuit are connected in parallel to the supply wire.

Thus viewed from a first aspect the present invention provides a power tool comprising:
a power supply wire for supplying power;
a power switch electrically connected to the power supply wire;
a first electrical circuit including the power switch;
a power indicating device positioned in visible proximity to an operator, the power indicting device including:
a power indicator which is capable of emitting radiation visible to the operator when power is on; and
a second electrical circuit including the power indicating device, wherein the second electrical circuit and the first electrical circuit are connected in parallel to the power supply wire.

By virtue of the power indicating device, the power tool of the invention allows the operator to conveniently judge whether power is on or off when the power tool stops working. This is particularly advantageous when the power plug is far away from the operator.

The power indicating device may be located in a housing. The housing may be the operator handle of the power tool. The radiation may be visible to the operator from an open end of the housing. The radiation may be visible to the operator from a window or aperture in a wall of the housing.

Preferably the power indicating device further includes a circuit board electrically connected to the power supply wire.

Particularly preferably the power indicator is mounted on the circuit board.

In a preferred embodiment the power tool further comprises a housing for the power indicating device; and a transparent sheath located adjacent to the power indicator and partially exposed from the housing (e.g. from the proximal end of the housing).

In a particularly preferred embodiment the power tool further comprises a wire sheath surrounding the power supply wire, wherein the transparent sheath is mounted between the wire sheath and the housing.

Preferably the power indicator is electrically connected to the circuit board.

In a particularly preferred embodiment, the power tool further comprises a housing for the power indicating device, wherein the housing incorporates a through hole and the power indicator is visibly received in the through hole.

Preferably the power indicator is a light emitting diode.

### BRIEF DESCRIPTION OF THE DRAWINGS

FIG. 1 is an exploded perspective view of a part of a power tool of a first embodiment of the present invention;

FIG. 2 is an assembled perspective view of the embodiment of FIG. 1;

FIG. 3 is a cross-sectional view along A-A of FIG. 4;

FIG. 4 is a cross-sectional view along C-C of FIG. 3;

FIG. 5 is a cross-sectional view along B-B of FIG. 4;

FIG. 6 is a schematic circuit diagram of an embodiment of the present invention;

FIG. 7 is an exploded perspective view of a part of a power tool of a second embodiment of the present invention; and

FIG. 8 is an assembled perspective view of the embodiment of FIG. 7.

### DETAILED DESCRIPTION OF THE INVENTION

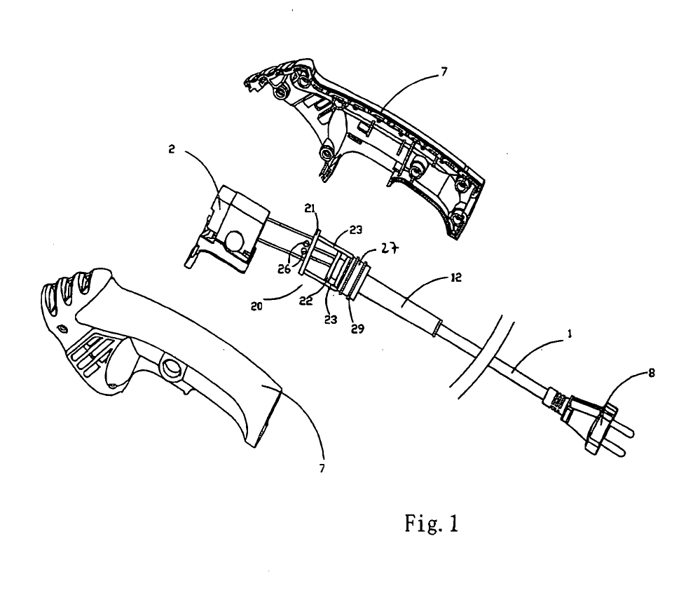

FIG. 1 illustrates an exploded perspective view of a part of a power tool according to a first embodiment of the present invention. The power tool includes generally a housing 7, a supply wire 1 and a power switch 2. A power indicating device 20 within the housing 7 is electrically connected to the supply wire 1. A wire sheath 12 encloses the supply wire 1 and is partially embedded in the housing 7. The wire sheath 12 forms a slot 22 and the housing 7 forms a projection 24 fitted in the slot 22. A power plug 8 is connected remotely at a proximal end of the supply wire 1 to be inserted into a power jack (not shown).

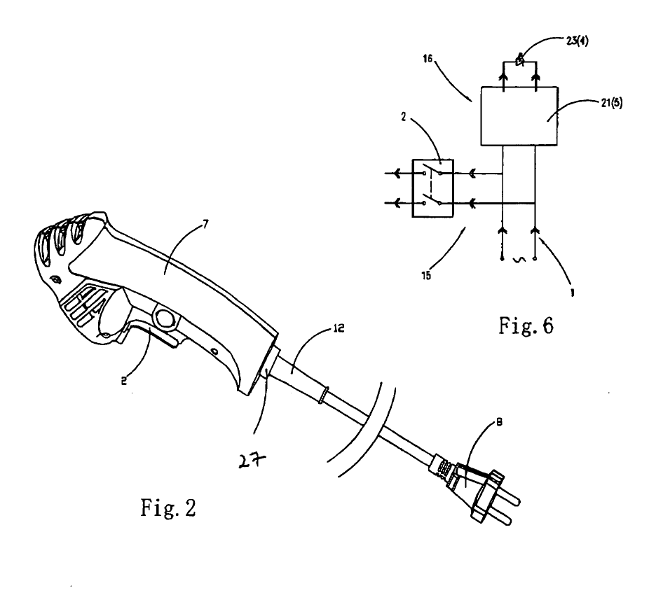

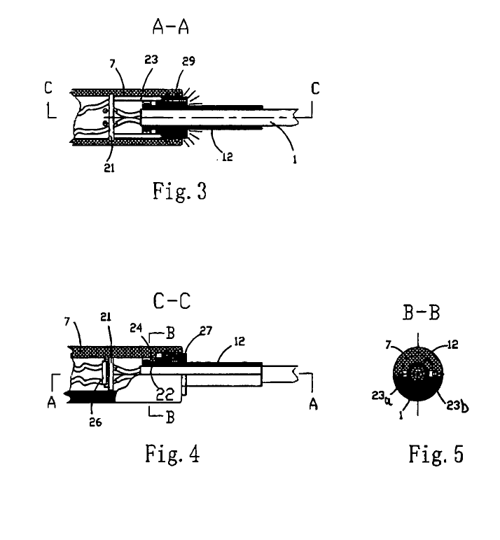

With particular reference to FIGS. 2 to 5, the power indicating device 20 includes a circuit board 21, a power indicator 23 electrically connected to the circuit board 21 and a transparent sheath 27. A pair of resistors 26 are positioned distal to the circuit board 21. The power indicator 23 is a pair of light emitting diodes (LEDs—23a, 23b) which are mounted proximally on the circuit board 21 and are electrically connected to the corresponding resistors 26. The transparent sheath 27 is cylindrical and embedded between the wire sheath 12 and housing 7 so as to be partially exposed from the housing 7. The transparent sheath 27 is adjacent to and aligned with the LEDs 23a, b. A pair of latching rings 29 are formed externally on the transparent sheath 27 and engage the housing 1.

FIG. 6 shows schematically a circuit diagram of the electrical connection between the power indicating device 20, the power switch 2 and the power supply wire 1. A first electric circuit 15 containing the power switch 2 and a second electrical circuit 16 containing the power indicating device 20 are connected in parallel to the power supply wire 1.

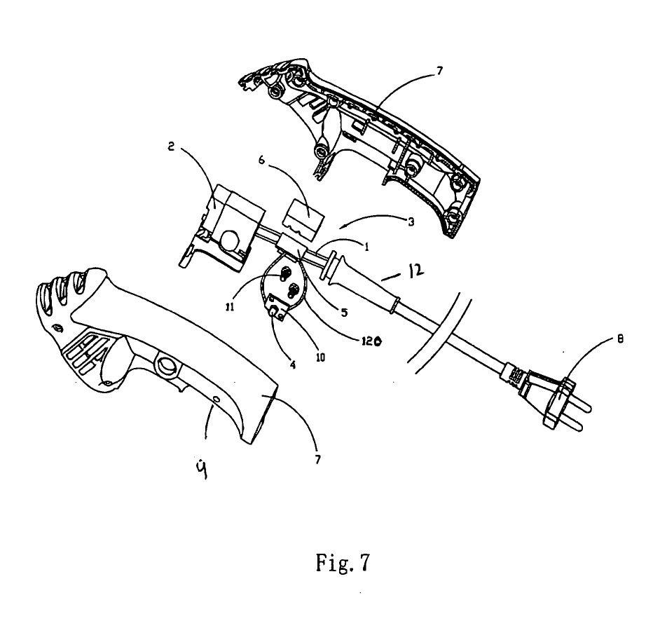

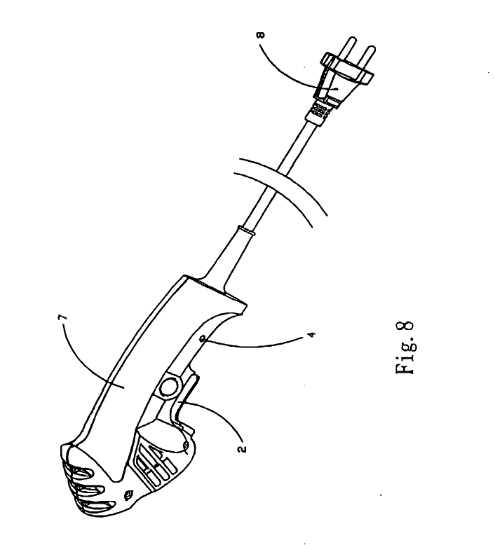

Referring to FIGS. 7 and 8, a power tool according to a second embodiment of the present invention is shown. Wherever possible, the reference numerals used hereinbefore in respect of FIGS. 1 to 6 are used in describing hereinafter the second embodiment. The power tool of the second embodiment includes a housing 7, a power supply wire 1, a power switch 2 and a power indicating device 3. The power indicating device 3 and power switch 2 are electrically connected to the supply wire 1. In the second embodiment, the power indicating device 3 includes a power indicator 4 and a circuit board 5 electrically connected to the power indicator 4 by wires 120 and a retaining device 6 for retaining the circuit board 5 in the housing 7. In this embodiment, the power indicator 4 such as an LED is positioned on a positioning plate 10 and is fixed to the housing 7 via a pair of screws 11. The housing 7 defines a through hole 9 and the power indicator 4 is received in the through hole 9 so as to be visible therethrough.

In accordance with the first and second embodiment, the operator can quickly judge whether or not power has been interrupted via the power indicator 4 and does not need to walk to the power plug 8.

1. A power tool comprising:
a power supply wire for supplying power;
a power switch electrically connected to the power supply wire;
a first electrical circuit including the power switch;
a power indicating device positioned in visible proximity to an operator, the power indicting device including:
a power indicator which is capable of emitting radiation visible to the operator when power is on; and
a second electrical circuit including the power indicating device, wherein the second electrical circuit and the first electrical circuit are connected in parallel to the power supply wire.

2. The power tool of claim 1 wherein the power indicating device further includes:
a circuit board electrically connected to the power supply wire.

3. The power tool of claim 2 wherein the power indicator is mounted on the circuit board.

4. The power tool of claim 2 further comprising:
a housing for the power indicating device; and
a transparent sheath located adjacent to the power indicator and partially exposed from the housing.

5. The power tool of claim 4 further comprising:
a wire sheath surrounding the power supply wire, wherein the transparent sheath is mounted between the wire sheath and the housing.

6. The power tool of claim 2 wherein the power indicator is electrically connected to the circuit board.

7. The power tool of claim 2 further comprising:
a housing for the power indicating device, wherein the housing incorporates a through hole and the power indicator is visibly received in the through hole.

8. The power tool of claim 1 wherein the power indicator is a light emitting diode.
